(19) United States
(12) Patent Application Publication
(10) Pub. No.: US 2025/0298672 A1
(43) Pub. Date: Sep. 25, 2025

(54) Flexible Cache Pooling for Network of Processing Cores

(71) Applicant: Tenstorrent USA, Inc., Austin, TX (US)

(72) Inventors: Wei Shu, Santa Clara, CA (US); Liang Yin, Palo Alto, CA (US); Xin He, Austin, TX (US); Hans Yeager, Chapel Hill, NC (US)

(21) Appl. No.: 18/887,051

(22) Filed: Sep. 17, 2024

Related U.S. Application Data
(60) Provisional application No. 63/568,451, filed on Mar. 22, 2024.

(51) Int. Cl. G06F 9/50

(52) U.S. Cl. CPC G06F 9/5072; G06F 9/5016

(57) ABSTRACT

Systems and methods related to networks of computational nodes such as cores in a multicore processor are disclosed herein. A disclosed method for executing a computation using a network of computational nodes includes assigning a component computation of the complex computation to a first computational node in the network of computational nodes. The first computational node includes a local memory. The local memory is reserved to be used for a cache by the computational node for executing the component computation. The disclosed method also includes reserving a remote memory on a second computational node in the network of computational nodes to be used for the cache by the computational node for executing the component computation.

### CROSS REFERENCE TO RELATED APPLICATIONS

This application claims the benefit of U.S. Provisional Patent Application No. 63/568,451, filed on Mar. 22, 2024, which is incorporated by reference herein in its entirety for all purposes.

### BACKGROUND

Many modern computing systems use the paradigm of distributed parallel computing embodied by, for example, a multicore processor. In these systems, a given complex computation is divided into multiple component computations which are distributed to the multiple cores in the multicore processor so that the cores can work in concert to complete the complex computation more effectively. More generally, these systems can be referred to as a network of computational nodes. In a multicore processor, collaboration among multiple cores is essential for efficiently executing the complex computation. The parallel architecture of multicore processors allows for concurrent computation which reduces overall processing time. The cores collaborate through efficient communication mechanisms, such as Networks-on-Chips (NoCs). Coordinated data sharing and synchronization mechanisms are implemented to ensure that intermediate results are exchanged seamlessly, enabling the collective execution of complex computations. This collaborative approach optimizes the utilization of available computational resources, enhances parallelism, and contributes to the overall acceleration of complex computations on multicore processors.

One of the main problems that has plagued current computing architectures that utilize the paradigm of parallel computation is that it is difficult to evenly divide complex computations into discrete elements for parallel execution. This causes problems in the case of multicore processors because the multiple cores are generally designed to be effectively homogenous while the workloads that are provided to individual cores at any given time during the execution of a complex computation can vary significantly. As such, there is almost always a relative mismatch between the resources available on each processing core and the portion of the overall workload assigned to an individual core. This can lead to underutilization of resources.

### SUMMARY

Systems and methods related to networks of computational nodes such as cores in a multicore processor are disclosed herein. In specific embodiments, the computational nodes can be designed to share access to their local memory to make the local memory available for use by another computational node. The local memory can be made available to serve as part of a cache or other memory of another computational node in the network. This process can involve repartitioning and reallocating what would otherwise be a private cache on a computational node to serve as part of the private cache of another computational node in the network. This repartitioning and reallocating can be performed based on initial configurations based on expected computations and respective needs for component computations or may be performed dynamically such as via distribution of source code or packets for the particular computations.

In specific embodiments of the invention, a method for executing a complex computation using a network of computation nodes is provided. The method comprises: assigning a component computation of the complex computation to a first computational node in the network of computational nodes, wherein the first computational node includes a local memory, and wherein the local memory is reserved to be used for a cache by the first computational node for executing the component computation; and reserving a remote memory on a second computational node in the network of computational nodes to be used for the cache by the first computational node for executing the component computation.

In specific embodiments of the invention, a network of computation nodes is provided. The network comprises: a set of instructions for a complex computation distributed amongst the computational nodes in the network of computational nodes; a first computational node; a memory on the first computational node reserved to be used as a cache by the first computational node for executing a component computation from the complex computation; a second computational node; and a memory on the second computational node reserved to be used for the cache by the first computational node for executing the component computation.

In specific embodiments of the invention, a method for operating a network of computational nodes is provided. The method comprises: sensing a decrease in demand for the network of computational nodes; putting a first computational node into an idle state, in response to sensing the decrease in demand, where a CPU of the first computational node is off in the idle state and a first memory and network layer circuitry of the first computational node are on in the idle state; assigning a component computation of a complex computation to a second computational node in the network of computational nodes; and executing the component computation using the second computational node, where the second computational node includes a second memory, the second computational node uses a cache to execute the component computation, and the cache uses the first memory, the network layer circuitry, and the second memory.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an illustration of different cores acquiring and giving up portions of their memory to collaboratively execute component computations of a complex computation in accordance with specific embodiments of the inventions disclosed herein.

FIG. 2 shows exemplary nodes with partitioned local memory in accordance with specific embodiments of the inventions disclosed herein.

FIG. 3 shows exemplary separated power supplies in accordance with specific embodiments of the inventions disclosed herein.

FIG. 4 depicts exemplary sharing of cache memory between nodes while the processors of one of the nodes are in a dormant state in accordance with specific embodiments of the inventions disclosed herein.

FIG. 5 depicts exemplary power loads at a data center performing complex parallel processing operations in accordance with specific embodiments of the inventions disclosed herein.

FIG. 6 depicts two computational nodes performing component computations of a complex computation with shared local cache memory in accordance with specific embodiments of the inventions disclosed herein.

FIG. 7 shown an exemplary embodiment of determining memory partitioning for virtualized compute resources based on component computational workloads for complex computations in accordance with specific embodiments of the inventions disclosed herein.

FIG. 8 shows a chip-level depiction of memory partitioning for virtualized compute resources in accordance with specific embodiments of the inventions disclosed herein.

FIG. 9 depicts exemplary steps of cache access for a pooled cache including a reserved cache on another computational node in accordance with specific embodiments of the inventions disclosed herein.

FIG. 10 shows exemplary steps of performing a complex computation in accordance with specific embodiments of the inventions disclosed herein.

FIG. 11 shows an example of a system executing a complex computation to produce an output in accordance with specific embodiments of the inventions disclosed herein.

FIG. 12 illustrates a method for executing a complex computation using a network of computational nodes in accordance with specific embodiments of the inventions disclosed herein.

FIG. 13 illustrates a method for operating a network of computational nodes in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods related to networks of computational nodes in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, which may be apparent to those skilled in the art but not explicitly shown or described, should not be construed as precluded.

Systems and methods related to interconnect fabrics and networks of computational nodes such as cores in a multicore processor are disclosed herein. In specific embodiments, the computational nodes can be designed to share access to their local memory to make the local memory available for use by another computational node. The local memory can be made available to serve as part of a cache or other memory of another computational node in the network. This process can involve partitioning, repartitioning, allocating, and reallocating what would otherwise be a private cache on a computational node to serve as part of the private cache of another computational node in the network. The repartitioning and reallocating can be performed based on initial configurations based on expected computations and respective needs for component computations or may be performed dynamically such as via distribution of source code or packets for the particular computations.

A local memory of a first computational node may be made available for use by a second computational node based on the first computational node being idle, inactive, or assigned a workload (e.g., component computation) that is not memory intensive. In other words, the local memory of the first computational node may be reallocated based on the first computational node not using (or not being expected to use) all or a portion of its local memory. The local memory of the first computational node may be reallocated to the second computational node based on the second node being assigned a workload that is memory intensive. In other words, the second node may use (or be expected to use) more than the memory (e.g., a second local memory) previously allocated to the second node. The second node may use the local memory of the first computational node rather than a separate memory, the separate memory may be slower than the local memory.

The local memory of the first computational node may be allocated to more than one node. For example, portions of the local memory may be allocated to the first computational node and the second computational node. As another example, portions of the local memory may be allocated to the second computational node, a third computational node, and a fourth computational node. The second computational node may be allocated local memory from multiple computational nodes. For example, the second computational node may have access to all or a portion of the local memory of the first computational node, a local memory of a third computational node, and its own local memory. The local memories may be made up of levels of caches.

When a first node within a network reserves a portion of its memory (e.g., some or all of its private cache memory) for exclusive use by a second node, the network as a whole may operate more efficiently by allowing memory constrained component computations to be performed such as by the second node, and by utilizing memory that might otherwise be unutilized based on the component computation assigned to the first node. Furthermore, in situations in which some nodes are not being utilized, they can still bear static current flow and consume a portion (e.g., 50%) of their total power consumption. Using approaches disclosed herein, these nodes can be placed in an idle state in which the computation portion of the node is entirely powered off while the memory portion of the node continues to operate and is used by another node in the network. In another example of multiple services having different computing and memory needs, services may be more effectively allocated between nodes to maximize utilization. By relinquishing memory capacity (e.g., cache) of a first core to a second core, the CPU of the first core may be turned off while maintaining the increased memory capacity of the second core. That is, the system may save power by turning off the CPU of the first core while still allowing the memory capacity of the first core to be used by the second core. In this example, the two cores may not share the memory capacity (e.g., the cache is not a shared cache between the cores either before or after relinquishing the memory capacity). Rather, the memory capacity as a whole may be relinquished to the second core.

Although the specific examples provided in this section are directed to a network of computational nodes in the form of a network on a chip (NoC) connecting multiple cores in a multicore processor, the approaches disclosed herein are broadly applicable to any interconnect fabric which interconnects and type of computational nodes. Furthermore, the networks in accordance with this disclosure can be implemented on a single chip system, in a multichip single package system, or in a multichip system in which the chips are commonly attached to a common substrate such as a printed circuit board (PCB), interposer, or silicon mesh. Any of these network implementations can be implemented using a variety of chip architectures, such as chiplets. Interconnect fabrics in accordance with this disclosure can also include chips on multiple substrates linked together by a higher-level common substrate such as in the case of multiple PCBs each with a set of chips where the multiple PCBs are fixed to a common backplane.

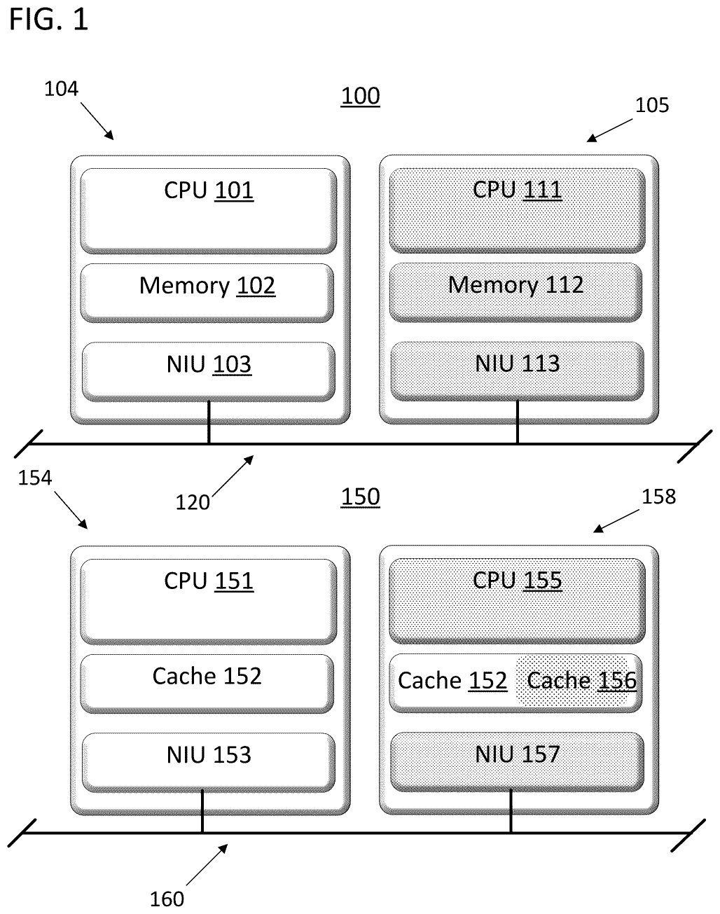

FIG. 1 provides an illustration of different cores acquiring and giving up portions of their memory to collaboratively execute component computations of a complex computation. A network of computational nodes in first configuration 100 is made up of self-contained cores, such as node 104 (e.g., a first chiplet core) and node 105 (e.g., a second chiplet core), which are connected via network 120 to form a NoC. Each core (e.g., node) in the NoC includes network layer circuitry such as a network interface unit (NIU), such as NIU 103 and NIU 113. The NIUs serve as part of the network layer of the NoC and allow for communication between cores. The NIUs can control routers on each of the cores and packetize information for transmission through the NoC. Each core further includes a local memory, such as memory 102 and memory 112. In the context of the present disclosure, a memory can serve as the working memory for the core and store data and/or instructions which will be used by the core to conduct computations. The memory can be an SRAM or any type of random-access memory. The memory can be a volatile or nonvolatile memory. Some or all of the memory can be utilized as a cache memory for the CPU on the core. In specific embodiments, the memory on a given core can be partitioned to serve as a private cache for the CPU on the core and it can be repartitioned to serve as part of a remote private cache for an alternative core in the network.

FIG. 1 also illustrates the network of the computational nodes (e.g., from first configuration 100) in second configuration 150 in which the memories have been repartitioned. As illustrated, memory 102 is used as remote cache 152 for CPU 151, while memory 112 has been partitioned to be used partly as remote cache 152 for CPU 151 and partly as cache 156 for use by CPU 155. Cache 152 can operate through the use of read and write requests sent through network 160 between node 154 and 158. Each node includes network layer circuitry such as an NIU, such as NIU 153 and NIU 157. In specific embodiments, the local memories can also be partitioned between being used as scratch pad memories for the CPU or as L1, L2, or L3 caches. In specific embodiments, a first computational node, such as node 104, may be assigned access to the memory of a second computational node, such as node 105, to be used as part of the cache for the first computational node. For example, CPU 101 could acquire a portion of memory 112 from node 105 to execute the component computation.

While a CPU is drawn in FIG. 1, the computational node can be another type of computational entity such as a graphics processing unit (GPU), neural processing unit (NPU), or digital signal processors (DSP). Local memory in caches can be implemented by high-speed static random-access memory (SRAM) and dynamic random-access memory (DRAM), etc. SRAM and DRAM provide faster read and write access to the computational nodes than electrically erasable programmable read-only memory (EEPROM). Caches can also include back stores with different kinds of memory which are broken into different levels based on how fast the memory is, with each additional level being occupied by slower memories.

In specific embodiments of the present disclosure, modifications are required in order to enable caches to be repartitioned for use as remote memory by alternative cores. Specifically, each computational node can include a controller that can set configuration registers of the local memory to assure that only a portion, or none at all, of the local memory is used by the local computational units. Each computational node can also include decode logic for receiving a packet with a request to repartition the local cache in a specific manner and to implement that instruction. The cache can be repartitioned into multiple pieces for multiple different nodes. In such embodiments, the computational node can also include the ability to associate specific partitions of the local memory with the cache of specific remote computational nodes. Furthermore, in these embodiments, a request to partition a cache, which is sent by a given computational node, can be accompanied by an identification of that given computational node to be used for this purpose.

In specific embodiments, the caches on the various computational nodes can be repartitioned in various ways. For example, the cache can be partitioned at boot time. A user can select a BIOS option “enable cache pooling for node X” and select “power off donator node” or “power on donator node, connect cache to memory” as options within the BIOS. As another example, the caches can be repartitioned through the compilation of the source code of the complex computation (i.e., machine code instructions generated by a compiler compiling the complex computation which determined that it is efficient to repartition and resize the different caches could instruct the cache to be repartitioned). Instructions to repartition can be sent in packets to the cores via the NoC which instructs them to repartition their cores accordingly.

When a first node within a network reserves a portion of its memory (e.g., some or all of its private cache memory) for exclusive use by a second node, the network as a whole may operate more efficiently by allowing memory constrained component computations to be performed (such as by the second node), and by utilizing memory that might otherwise be unutilized based on the component computation assigned to the first node. Furthermore, using approaches disclosed herein, otherwise unutilized nodes may be placed in an idle state in which the computation portion of the node is entirely powered off while the memory portion of the node continues to operate and is used by another node in the network. Services may be more effectively allocated between nodes to maximize utilization.

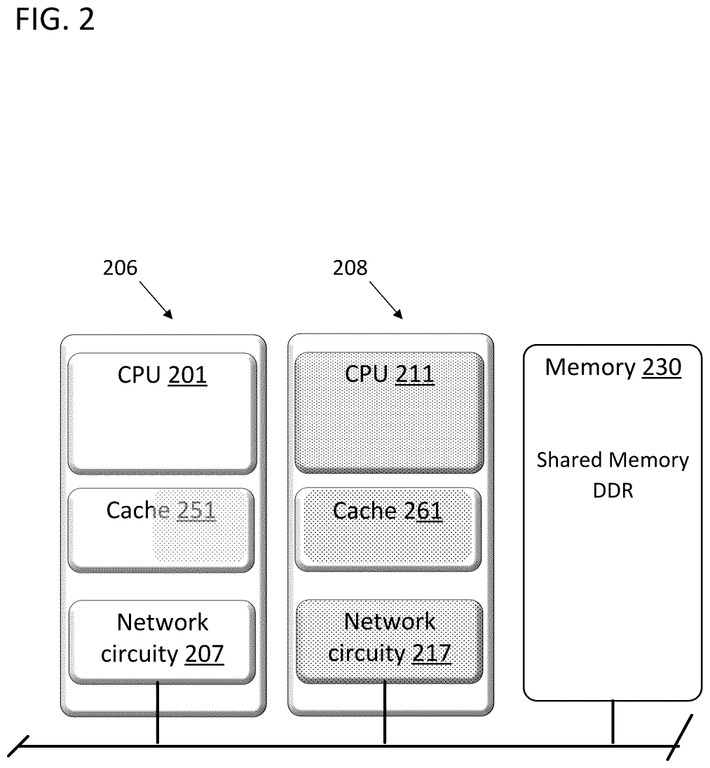

FIG. 2 shows exemplary nodes with partitioned local memory in accordance with an embodiment of the present disclosure. The nodes (e.g., each including a core) are depicted in a simplified manner for purposes of illustrating local memory partitioning, and accordingly, it will be understood that the nodes and/or cores described herein may include a variety of suitable types, numbers, and configurations of processors, memories, network circuitry, registers, routers, and the like. For example, in the alternative or in addition to cache memories, other memory such as scratch pad memory can be partitioned in accordance with the examples provided herein. In the exemplary embodiment depicted in FIG. 2, each of the nodes includes a respective local CPU, cache, and network circuitry, with node 106 being a first chiplet including CPU 201, cache 251, and network circuitry 207, and node 208 being a second chiplet including CPU 211, cache 261, and network circuitry 217. The nodes 206 and 208 are connected to each other via a network, as well as to a shared memory such as a shared DDR memory 230. CPU 201 may share characteristics of CPU 101, CPU 211 may share characteristics of CPU 111, cache 251 may share characteristics of memory 102, cache 261 may share characteristics of memory 112, network circuitry 207 may include an NIU similar to NIU 103, and network circuitry 217 may include an NIU similar to NIU 113.

In the embodiment depicted in FIG. 2, cache 251 of node 206 has been partitioned such that a portion of cache 251 is allocated for use by the CPU 211 of node 208, as depicted by the grayed portion within cache 251. Similarly, the cache 261 of node 208 or a portion thereof may be partitioned for usage by a CPU of another node (not depicted in FIG. 2). As described herein, the portioning may be performed in various ways to dynamically adjust the partitioning in accordance with the present or expected computational workload. A shared memory such as memory 230 remains available via the network to either of node 206 or node 208, including when a respective cache (e.g., cache 251 or 261) is partitioned, such that any temporary memory needs during such a time may be handled by memory 230, albeit at an increased latency compared to if the request could be handled locally. Such use of memory 230 as a backup allows the partitioned memory to temporarily handle spikes in activities or manage memory while the partitioning is being updated and can also be used to supplement a CPU, such as CPU 201 which has had a portion of its cache taken away for use by another CPU, such as CPU 211.

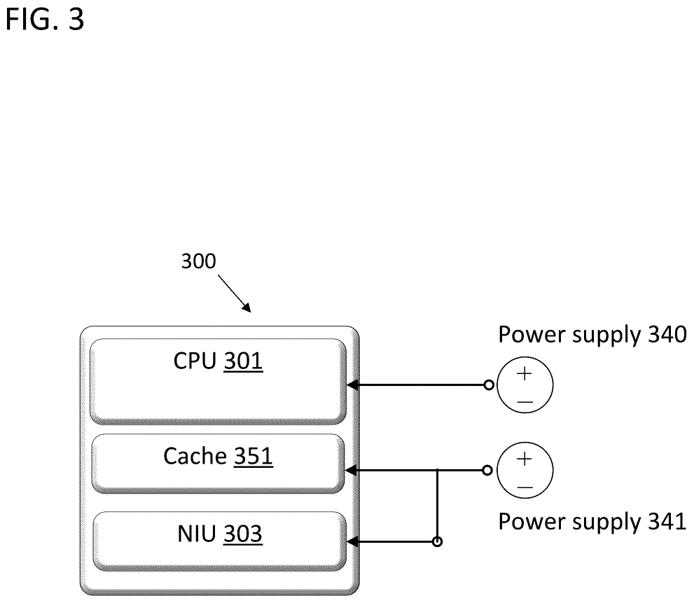

FIG. 3 shows exemplary separated power supplies in accordance with an embodiment of the present disclosure. Node 300 is depicted in simplified form as a chiplet including CPU 301, cache 351, and NIU 303 that function as described herein. As depicted in FIG. 3, CPU 301 is connected to power supply 340 that is separate from power supply 341. The power supplies 340 and 341 are depicted in simplified form, and are intended to merely illustrate that within each node, power may be separately controlled as between internal processing units (e.g., CPUs, GPUs, DSPs, et.) and other components of a node such as network circuitry (e.g., NIUs, routers, etc.) and memory (e.g., local caches, scratch pad memory, etc.). For example, the power of a processor such as CPU 301 may be controlled such that the processor is dormant or idle at certain times, for example, via power source outputs, switches, internal sleep modes, power gating, the activation or deactivation of power, current, or voltage regulators, clock gating, dynamic voltage and frequency scaling (DVFS), and the like. Control for these various methods of rendering the processor dormant or idle can be external or internal to the node. The structures that execute these various methods of rendering the node dormant or idle can likewise be external or internal to the node. Regardless of how the power to the processor such as CPU 301 is controlled, the node 300 may have the processor unpowered or in a low power state while memory such as cache 351 and networking components such as NIU 303 are fully operable, enabling usage of the memory such as cache 351 by another processing core of another node (e.g., via NIU 303), while the CPU 301 does not consume power.

Using approaches disclosed herein, otherwise unutilized nodes may be placed in an idle state in which the computation portion of the node is entirely powered off while the memory portion of the node continues to operate and is used by another node in the network. Services may be more effectively allocated between nodes to maximize utilization. The network as a whole may operate more efficiently by utilizing memory that might otherwise be unutilized based on the idle state.

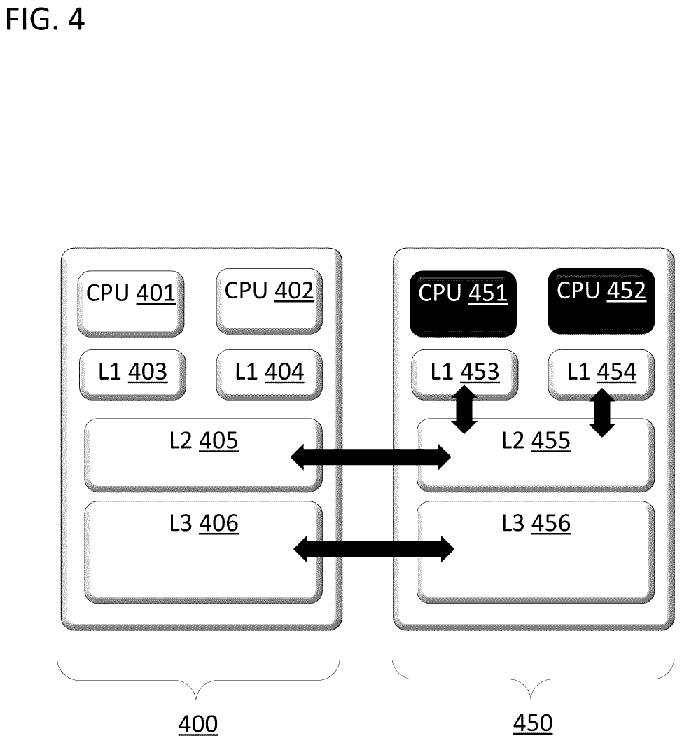

FIG. 4 depicts exemplary sharing of cache memory between nodes while the processors of one of the nodes are in a dormant state. FIG. 4 depicts exemplary computational nodes 400 and 450 (e.g., in some embodiments, each a respective chiplet), which are depicted in simplified form to depict cache sharing and processor idling, for example, without depicted additional (e.g., non-cache) internal memory of the nodes, networking components such as NIUs, and routers, and the like. It will be understood that each of the nodes may include any suitable combination of cores, processors, memories, networking, and other components, and that the nodes 400 and 450 are in communication via a network or interconnect fabric, or other suitable communication paths.

In the embodiment depicted in FIG. 4, each of the nodes 400 and 450 includes two processors (e.g., processors 401 and 402 for node 400, and processors 451 and 452 for node 450), two level one (“L1”) caches (e.g., L1 caches 403 and 404 for node 400, and L1 caches 453 and 454 for node 450), one level two (“L2”) cache (e.g., L2 cache 405 for node 400, and L2 cache 455 for node 450), and one level three (“L3”) cache (e.g., L3 cache 406 for node 400, and L3 cache 456 for node 450).

In an example, it may be determined that the particular computational load that is being allocated between nodes requires relatively more memory usage within the network (larger network including additional nodes connected to nodes 400 and 450 not depicted) than processor utilization. Accordingly, it may be determined that the memory from some nodes (e.g., node 450) may be utilized as remote cache for other nodes (e.g., node 400) via the network/interconnect fabric (e.g., as indicated by arrows in FIG. 4) while the processors 451 and 452 can be inactive or idle (e.g., depicted in black), for example, by disconnecting them from power or otherwise reducing their power usage such as is described with respect to FIG. 3. Portions of nodes such as some or all the cache memory (L1 cache 453, L1 cache 454, L2 cache 455, L3 cache 456) and networking components such as a NIU (not depicted) may remain powered to allow other nodes such as node 400 to utilize the memory within node 450.

While FIG. 4 and other figures herein depict pooling of caches between two nodes, it will be understood that caches may be pooled in multiple manners between a variety of subsets of nodes. For example, some of the caches of a single node (e.g., node 450) could be allocated entirely to different nodes, caches can be partitioned between different nodes, and combinations thereof. In this manner, the memory of a node that has inactive or idle processors may be fully utilized, and may be utilized in the manner most suitable to parallel processing, for example, by allocating different caches or portions thereof based on another node's usage of memory and requirements for speed of memory access. In specific embodiments, the caches on the various computational nodes can be repartitioned in various ways. For example, the cache can be partitioned at boot time, by user selection, programmatically (i.e., via an encoding in the source code of the complex computation), or through the compilation of the source code of the complex computation. As described herein, the process of determining respective component computation workloads and providing partitioning instructions can be performed at a variety of times and the partitioning may be updated at different times and/or intervals, for example, via network configuration messages, distribution to nodes of source code that defines complex computations, distribution of packets to nodes for complex computations, and the like. A node may include one or more (e.g., two) separate processing cores (e.g., CPUs) and cache memory including one or more L1 caches, one or more L2 caches, and one or more L3 caches. Pooling memory for the partitioning and reserving of memory resources may be performed on any suitable number and types of nodes, number and types of processing cores, and number and types of memories.

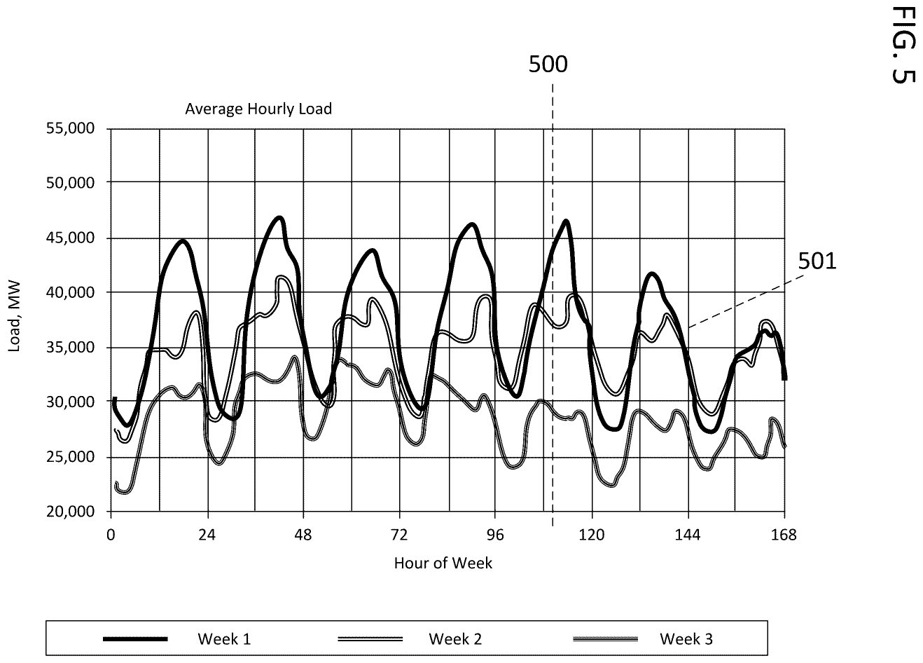

FIG. 5 depicts the exemplary power load at a data center performing complex parallel processing operations such as for artificial intelligence or neural network workloads under three different load conditions during different weeks. In the example depicted in FIG. 5, the load conditions (e.g., temperature, humidity, etc.) are relatively consistent within a given week, although the load conditions vary between weeks. Week 1 corresponds to a highest load condition (e.g., with a high temperature, etc.), Week 2 corresponds to a lower load condition than Week 1, and Week 3 corresponds to a lower load condition than either Week 1 or Week 2. Load can be influenced by variation in human behavior. For example, less computations are required when most people in a given time zone are sleeping. The fluctuation in load can also be influenced by variations in human behavior beyond the scope of regular day-night cycle. For example, there may be more power consumption associated with a specific application on specific days (e.g., at home video streaming may be consumed more during public holidays). In specific embodiments, a decrease in demand for the network of computational nodes may be sensed. For example, the data center may sense decrease 501 or one or more components of the system performing the complex parallel processing operations may sense decrease 501. A decrease in demand may refer to a decrease in current demand, a decrease in daily demand, a decrease in average demand, etc. The abscissa of FIG. 5 is in hours, and includes the total number of hours (168 hours) in a week of usage while the ordinate of FIG. 5 represents the average hourly load in Megawatts which illustrates the major impact improvements in the power performance of processing architectures can have on the power consumption of modern society.

A typical data center must go into a power saving mode when certain power consumption levels are reached, which may be based on current power, average power, running average of power, change in load, etc. In the example depicted in FIG. 5, a peak power consumption limit 500 during the Week 1 loading condition is reached at approximately 108 hours, as indicated by a dashed line. It will be noted that prior to peak power consumption limit 500, the loading condition for Week 1 had a relatively consistent consumption pattern throughout each day, while after reaching the peak power consumption limit 500, the power consumption is reduced during the last two days of usage, with an additional reduction on the final day. Utilizing the selective deactivation of processing cores as described herein provides an effective way to efficiently reduce power consumption within a power center, by reducing the power consumption of processing cores that are not actively processing workloads and optimizing the operations of the active processing cores. Accordingly, power consumption can be reduced even in the Week 1 conditions throughout the entire week, reducing the average workload and avoiding peak power consumption limits altogether. If a peak power consumption limit is nonetheless reached, power consumption can be further reduced while limiting the impact on processing capacity. Specific embodiments of the inventions as disclosed herein may allow (e.g., greatly help) a data center to maintain or dynamically reduce power consumption.

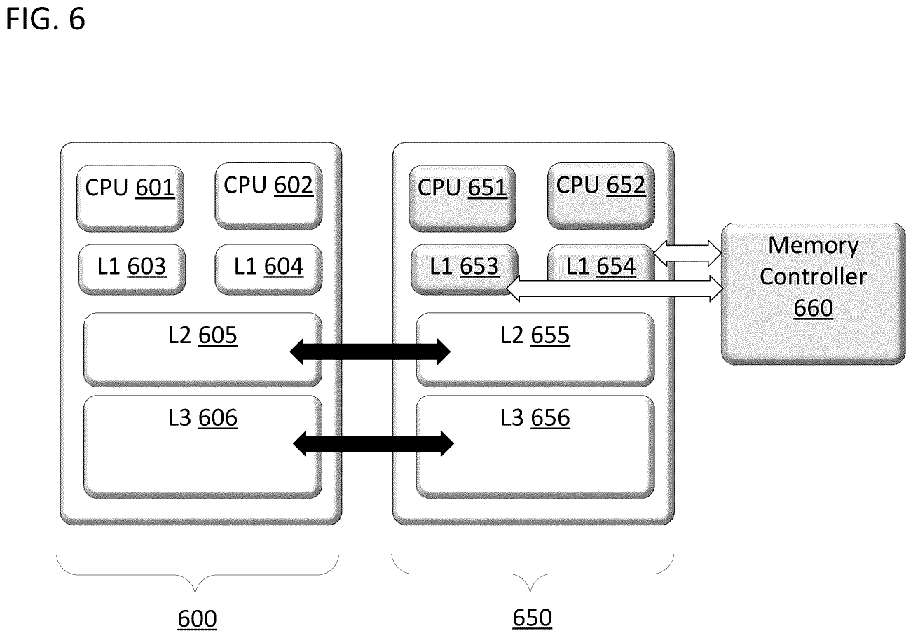

FIG. 6 depicts two computational nodes performing component computations of a complex computation with shared local cache memory in accordance with an embodiment of the present disclosure. FIG. 6 depicts exemplary computational nodes 600 and 650 (e.g., in some embodiments, each a respective chiplet), which are depicted in simplified form to depict cache sharing, for example, without depicting additional (e.g., non-cache) internal memory of the nodes, networking components such as NIUs, and routers, and the like. It will be understood that each of the nodes may include any suitable combination of cores, processors, memories, networking, and other components, and that the nodes 600 and 650 are in communication via a network or interconnect fabric, or other suitable communication paths.

In the embodiment depicted in FIG. 6, each of the nodes 600 and 650 includes two processors (e.g., processors 601 and 602 for node 600, and processors 651 and 652 for node 650), two L1 caches (e.g., L1 caches 603 and 604 for node 600, and L1 caches 653 and 654 for node 650), one L2 cache (e.g., L2 cache 605 for node 600, and L2 cache 655 for node 650), and one L3 cache (e.g., L3 cache 606 for node 600, and L3 cache 656 for node 650). Additionally, a memory controller 660 is in communication with at least node 650, with the memory controller 660 either internal to node 650 or external to node 650 (e.g., via a communication path such as a network or interconnect fabric) in order to provide node 650 access to additional memory (e.g., shared DDR memory, not depicted in FIG. 6).

In the embodiment of FIG. 6, it has been determined that the component computations to be processed by node 600 are expected to require additional memory compared to the component computations to be processed by node 650. Accordingly, node 650 has been partitioned (e.g., via partitioning instructions provided during a configuration, distribution of source code for the complex computation, with distribution of instruction packets for the complex computation, or otherwise) such that its private L2 cache 655 and L3 cache 656 are reserved exclusively as remote memory for node 600 (e.g., as illustrated by arrows and common white shading in FIG. 6) such as via the NoC network and/or fabric interconnect. Thus, the processors 601 and 602 of node 600 have the following caches available for storage of data while performing complex computations assigned to node 600: L1 caches 603 and 604, L2 caches 605 and 655, and L3 caches 606 and 656. The L1 caches 653 and 654 remain reserved for the processors 651 and 652 of node 650, and are utilized by those processors to store information for use in executing component computations assigned to node 650. Memory controller 660 is utilized to access additional memory (e.g., by node 600 or 650, with node 650 depicted accessing additional memory in FIG. 6), for example, if the L1 caches 653 and 654 do not have adequate memory for some portion of the component computations assigned to node 650.

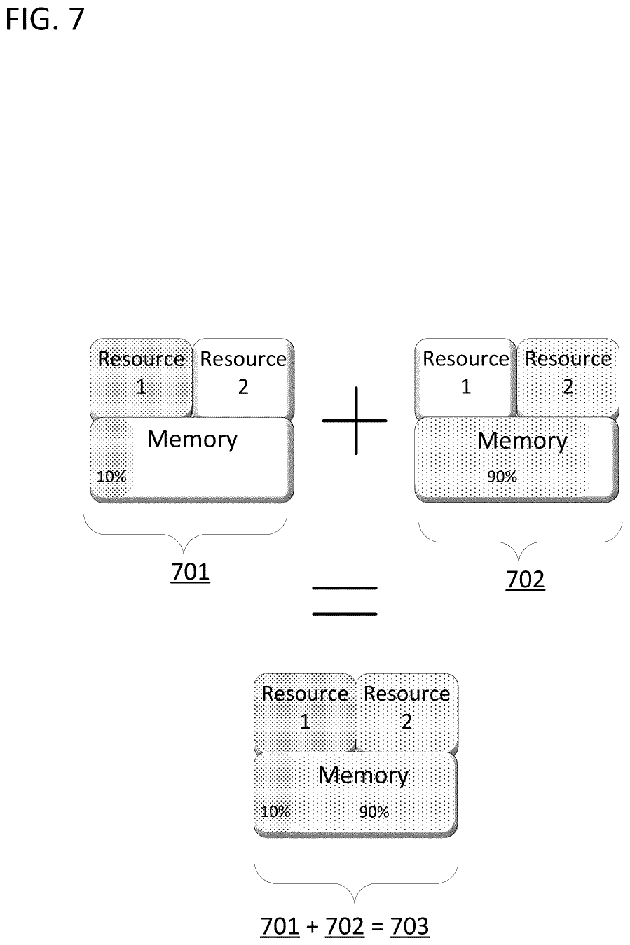

FIG. 7 shows an exemplary embodiment of determining memory partitioning for virtualized compute resources based on component computational workloads for complex computations in accordance with an embodiment of the present disclosure. As described herein, the process of determining respective component computation workloads and providing partitioning instructions can be performed at a variety of times and the partitioning may be updated at different times and/or intervals, for example, via network configuration messages, distribution to nodes of source code that defines complex computations, distribution of packets to nodes for complex computations, and the like. In the embodiment of FIG. 7, compute resources (depicted as Resource 1 and Resource 2) are depicted in a combined manner for each of service 701, service 702, and combined service structure 703, i.e., with separate processing cores for the two respective compute resource blocks (e.g., nodes) and with all of the memory between the multiple nodes pooled as a single “memory.” It will be understood that a similar pooling for partitioning and reserving of memory resources may be performed on any suitable number and types of nodes, number and types of processing cores, and number and types of memories.

In an embodiment, it may be determined (e.g., via a service level agreement) that a first service 701 is less memory sensitive, requiring one full processing resource and 10% of the overall memory resource for L1 cache. The service can be compute intensive and use nodes with less cache access and memory. Since service 701 is not cache dependent, it can give up some of its cache space, and other services can later acquire the cache space for their usage. A second service 702 may be more memory sensitive, requiring a processing resource and 90% of the overall memory resource. Accordingly, combined service structure 703 allocates one full processing resource (e.g., of a computational node) to each of first service 701 and second service 702, while partitioning and reserving memory (e.g., caches and other memory) as described herein such that second service 702 has reserved some memory (e.g., L2 and L3 cache) of a node performing first service 701, while the node performing service 701 reserves enough of its own memory (e.g., L1 caches) for performing its cache and frequency sensitive operations.

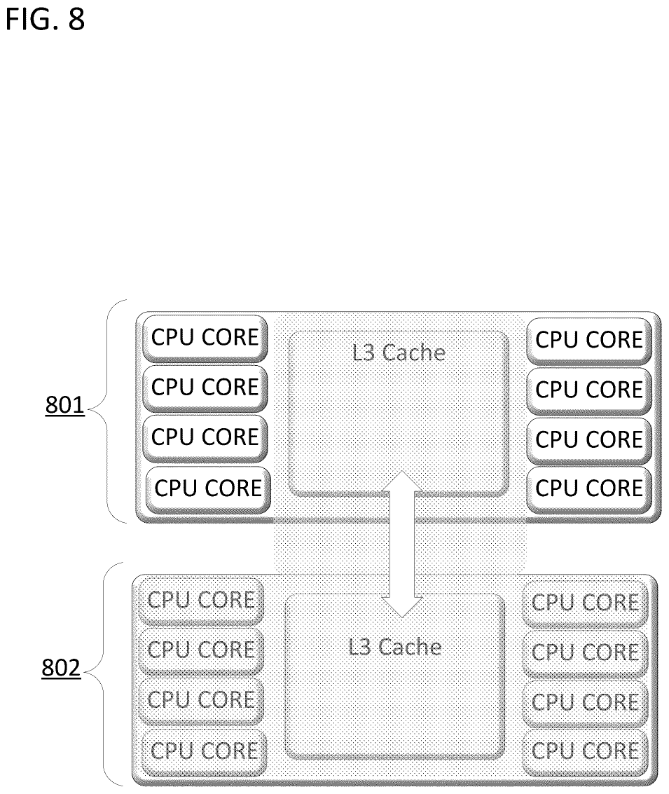

FIG. 8 shows a chip-level depiction of memory partitioning for virtualized compute resources based on component computational workloads for complex computations in accordance with an embodiment of the present disclosure. FIG. 8 depicts selected compute resources allocated to a first node 801 and to a second node 802 (e.g., in some embodiments, each a respective chiplet). It will be understood that the nodes of FIG. 8 are examples only, and that a number of components have been excluded from the depiction of FIG. 8 for purposes of depicting service virtualization as described herein.

As is depicted in FIG. 8, each of first node 801 and second node 802 include multiple processing cores (e.g., 8 CPU cores) and memory (e.g., a 32 MB L3 cache). Other memory such as L1 cache, L2 cache, scratch pad memory, and other local memory are not depicted for nodes 801 and 802, and remain reserved for those respective nodes and the services running on their CPU cores. A first service has a profile such as that of first service 701 and is latency, cache and frequency sensitive, and thus requires at least its local L1 cache and local processors, shown in FIG. 8 as including the depicted processing cores of node 801 (e.g., depicted without shading) and some of its local memory (e.g., L1 and L2 cache, not depicted in node 801 of FIG. 8 but not allocated to the second service). A second service has a profile such as that of service 702 and is memory sensitive, and thus includes all the processing and memory resources of node 802 and has also reserved the L3 cache of node 801, depicted with gray shading in FIG. 8, as remote memory accessible to node 802. In this manner, the second service (e.g., service 702) is provided with larger on-chip cache (e.g., including L3 cache from node 801) while the first service (e.g., service 701) relinquishes those cache resources for use by second service. This allows services to run on hardware with high utilization and the best fit for different configurations and computational loads.

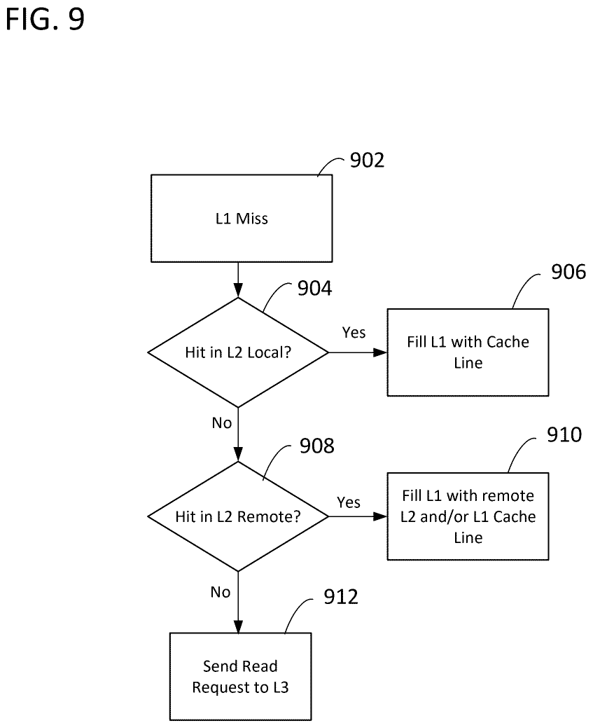

FIG. 9 depicts exemplary steps of cache access for a pooled cache including a reserved cache on another computational node (e.g., another chiplet) in accordance with an embodiment of the present disclosure. Although particular steps are depicted in a particular order in FIG. 9, it will be understood that the order of certain steps may be modified in accordance with the present disclosure and that steps may be added or removed in certain embodiments. As described herein, memory (e.g., cache memory) from another computational node may be reserved for the first computational node, for example, based on expected usage patterns for respective component computations to be performed by the nodes. Accordingly, the first computational node may have access to its own caches and also to caches reserved within other nodes, such as the L2 cache in another node. It will be understood that with different cache and memory partitioning the steps described in FIG. 9 will be modified.

At step 902, a first computational node (e.g., a first chiplet) determines that there is a miss on its own L1 cache. Assuming there has been a miss within the first node's own L1 cache, processing continues to step 904. At step 904, it is determined whether there is a cache hit in the local L2 cache. If there is a cache hit in the local L2 cache, processing continues to step 906, in which the L1 cache is filled with the cache line corresponding to the hit. If there is not a cache hit in the local L2 cache, processing continues to step 908.

At step 908, it is determined whether there is a cache hit in the remote L2 cache, i.e., the cache of another computational node that has been reserved for the node performing the read access request. If there is a cache hit in the remote L2 cache, processing continues to step 910, in which the L1 cache is filled with the remote L2 cache and/or the L1 cache line, as appropriate. If there is not a cache hit, processing continues to step 912, at which the read request is sent to the local L3 cache for processing.

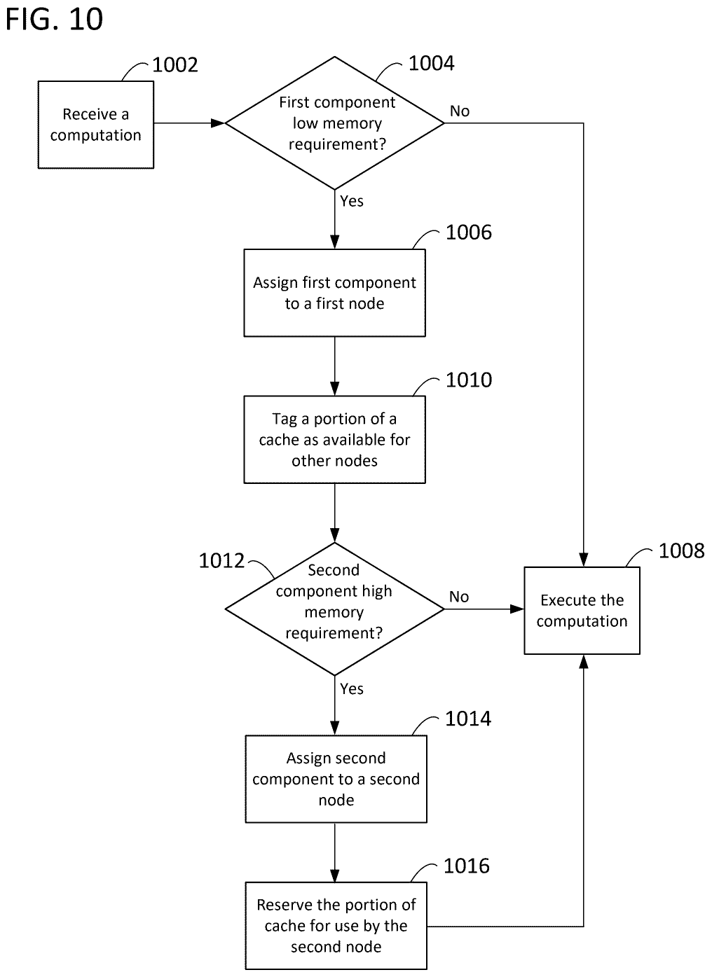

FIG. 10 shows exemplary steps of performing a complex computation in accordance with an embodiment of the present disclosure. The steps may be performed by a system including a combination of nodes, cores, processors, memories, networking, controllers, or other components such as those described in the present disclosure. Although particular steps are depicted in a particular order in FIG. 10, it will be understood that the order of certain steps may be modified in accordance with the present disclosure and that steps may be added or removed in certain embodiments. For example, in specific embodiments, steps (or portions of steps) may be performed in a different order, duplicated, omitted, or otherwise deviate from the organization shown.

Caches may be pooled in multiple manners between a variety of subsets of nodes. For example, some of the caches of a single node could be allocated entirely to different nodes, caches can be partitioned between different nodes, and combinations thereof. In this manner, the memory of a node that has inactive or idle processors may be fully utilized, and may be utilized in the manner most suitable to parallel processing, for example, by allocating different caches or portions thereof based on another node's usage of memory and requirements for speed of memory access. In specific embodiments, the caches on the various computational nodes can be repartitioned in various ways. For example, the cache can be partitioned at boot time, by user selection, programmatically (i.e., via an encoding in the source code of the complex computation), or through the compilation of the source code of the complex computation. As described herein, the process of determining respective component computation workloads and providing partitioning instructions can be performed at a variety of times and the partitioning may be updated at different times and/or intervals, for example, via network configuration messages, distribution to nodes of source code that defines complex computations, distribution of packets to nodes for complex computations, and the like. A node may include one or more (e.g., two) separate processing cores (e.g., CPUs) and cache memory including one or more L1 caches, one or more L2 caches, and one or more L3 caches. Pooling memory for the partitioning and reserving of memory resources may be performed on any suitable number and types of nodes, number and types of processing cores, and number and types of memories.

At step 1002, a computation (e.g., a complex computation) may be received. The computation may be made up of a set of component computations (e.g., or a set of instructions).

At step 1004, whether a first component computation has a low memory requirement may be determined. Multiple component computations may be reviewed. In specific embodiments, it may be determined (e.g., via a service level agreement) that a first component computation is less memory sensitive, requiring one full processing resource and 15% of the first node cache. The first component computation may be compute intensive. If a component computation (e.g., a first component computation) with a low memory requirement is found, then the process may continue to step 1006. If no component computation (e.g., of the set of component computations) with a low memory requirement is found, then the process may continue to step 1008.

At step 1006, the first component computation may be assigned to a first node. In specific embodiments, the first component computation may be assigned to the first node before it is determined whether the first component computation has a low memory requirement. In other words, step 1006 may occur before step 1004.

At step 1008, the computation may be executed. Executing the computation may include assigning each component computation associated with the computation to a node and executing each component computation. In specific embodiments, a memory controller may be utilized to access additional memory. For example, the L1 caches of the first node may not have adequate memory for executing the first component computation assigned to the first node and additional memory may be accessed. As another example, if the second component computation requires more memory than the cache of the second node and the reserved portion of the cache of the first node for execution, additional memory may be accessed. The system may allocate one full processing resource (e.g., of a computational node) to each of the first component computation and the second component computation, while partitioning and reserving memory (e.g., caches and other memory) such that second component computation reserves some memory (e.g., L2 and L3 cache) of the first node and the second node, while the first component computation reserves enough memory in the first node (e.g., L1 caches) for performing its cache and frequency sensitive operations.

At step 1010, a portion of a cache of the first node may be tagged as available for other nodes to use. For example, it may be estimated that the first component computation executed by the first node will only use 10% of the cache associated with the first node. The other 90% of the cache may be tagged as available for other nodes to use when executing their respective component computations. The first node may be partitioned (e.g., via partitioning instructions provided during a configuration, distribution of source code for the complex computation, with distribution of instruction packets for the complex computation, or otherwise). In specific embodiments, the first node may be partitioned such that its private L2 cache and L3 cache are reserved exclusively as remote memory for other nodes such as via the NoC network and/or fabric interconnect. In specific embodiments, the first node may be partitioned such that a portion (e.g., less than all) of its private L2 cache and L3 cache are reserved as remote memory for other nodes. The first component computation may not be cache dependent, the first node may give up some or all of its cache space, and other component computations may later (e.g., at step 1016) acquire the cache space for their usage.

In specific embodiments, a portion of the cache of the first node may be tagged as available for other nodes to use without the first node being associated with a first computational component (e.g., steps 1004 and 1006 are skipped). For example, the first node (e.g., processor of the first node) may be inactive or idle. In specific embodiments, the first node may be inactive or idle due to a decrease in workload for the system. It may be determined that at least a portion of the cache from the first node may be utilized as a remote cache for other nodes via a network/interconnect fabric while the processor of the first node is inactive or idle. For example, the processor of the first node may be disconnected from power or otherwise have its power usage reduced. Portions of the first node (such as some or all the cache memory and networking components such as a NIU) may remain powered to allow other nodes to utilize the memory within the first node. In this case, the cache of the first node may be tagged as available for use by other nodes without the first node being assigned a computational component.

At step 1012, whether a second component computation has a high memory requirement may be determined. Multiple component computations may be reviewed. In an example, it may be determined that the second component computation requires relatively more memory usage within the network than processor utilization. It may be determined that the second component computation is expected to require additional memory compared to the first component computation. The second component computation may be more memory sensitive, requiring a processing resource, 100% of the second node cache, and 85% of the first node cache. In specific embodiments, step 1012 may occur before step 1004. That is, the system may find a computational component with a high memory requirement before finding a computational component with a low memory requirement. If a component computation (e.g., a second component computation) with a high memory requirement is found, then the process may continue to step 1014. If no component computation (e.g., of the set of component computations) with a high memory requirement is found, then the process may continue to step 1008.

At step 1014, the second component computation may be assigned to a second node. In specific embodiments, the second component computation may be assigned to the second node before it is determined whether the second component computation has a high memory requirement. In other words, step 1014 may occur before step 1012.

At step 1016, the portion of the cache of the first node (e.g., tagged as available for use by other nodes at step 1010) may be reserved for use by the second node. For example, 90% of the cache may be tagged as available for other nodes to use when executing their respective component computations. Thus, the second node may reserve up to 90% of the cache. In specific embodiments, all 90% of the cache is reserved by the second node. In specific embodiments, less than 90% of the cache is reserved by the second node. For example, it may be estimated that the second node will use 40% of the cache. In specific embodiments, another (e.g., third) node may also reserve a portion of the cache. For example, 10% of the cache of the first node may be reserved by the first node, 40% of the cache of the first node may be reserved by the second node, and 50% of the cache of the first node may be reserved by another node. In specific embodiments, the processors of the second node may have the following caches available for storage of data while performing the component computation assigned to the second node: the L1 caches of the second node, at least a portion of the L2 cache of the first node, the L2 cache of the second node, at least a portion of the L3 cache of the first node, and the L3 cache of the second node. In specific embodiments, the L1 caches of the first node may remain reserved for the processors of the first node, which are utilized by those processors to store information for use in executing the first component computation (assigned to the first node).

After performing step 1016, the process may continue to step 1008. In specific embodiments, steps 1004 through 1016 may be performed multiple times for a given computation (e.g., received at step 1002). That is, there may be multiple computational components that have low memory requirements assigned to various nodes. The various nodes may tag portions of their associated caches as available for other nodes. There may be multiple computational components with high memory requirements that reserve these portions. In other words, steps 1004 through 1016 may be performed multiple times with a third and fourth node, a fifth and sixth node, a seventh and eight node, etc. Additionally, some caches may include more than two portions reserved by more than two nodes. For example, a first node may allocate its associated cache space to itself, a second node, and a third node. Additionally, some nodes may reserve more than two portions of nodes. For example, a first node may allocate its associated cache space to itself, a second node, and a third node; the second node may allocate its associated cache space to itself; and the fourth node may allocate cache space to itself and the second node. In this example, the second node reserves cache space in the cache of the first node, the cache of the second node, and the cache of the fourth node.

When a first node within a network reserves a portion of its memory (e.g., some or all of its private cache memory) for use by a second node, the network as a whole may operate more efficiently by allowing memory constrained component computations to be performed (such as by the second node), and by utilizing memory that might otherwise be unutilized based on the component computation assigned to the first node. Furthermore, using approaches disclosed herein, otherwise unutilized nodes may be placed in an idle state in which the computation portion of the node is entirely powered off while the memory portion of the node continues to operate and is used by another node in the network. Services may be more effectively allocated between nodes to maximize utilization.

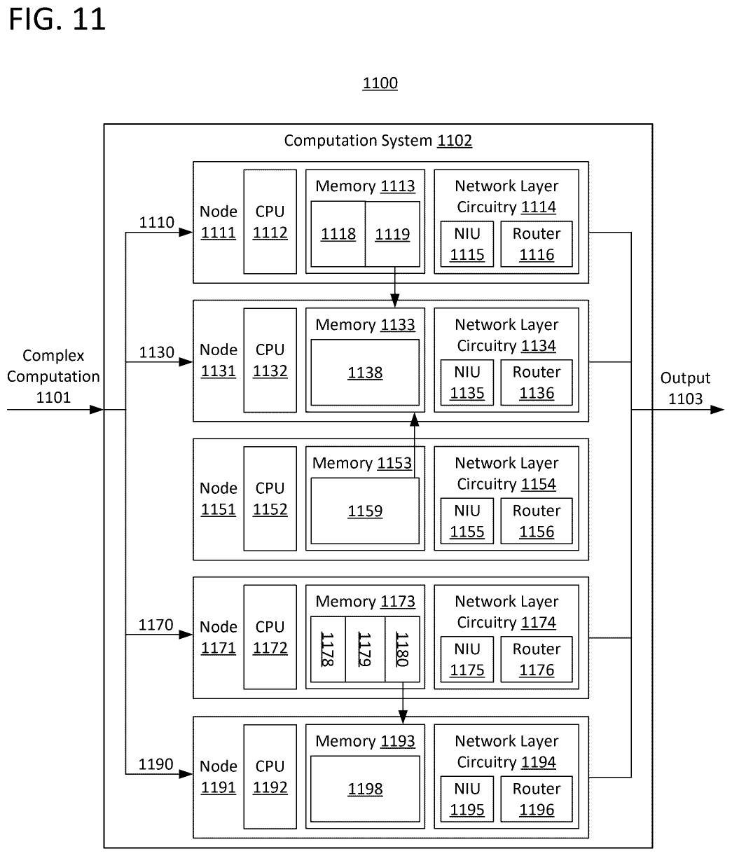

FIG. 11 shows an example of system 1100 executing complex computation 1101 to produce output 1103 in accordance with an embodiment of the present disclosure. System 1100 may include computation system 1102. Computation system 1102 may include multiple nodes. Each node may include a CPU, a memory, and a network layer circuitry. The network layer circuitry may include an NIU and a router. For example, nodes 1111, 1131, 1151, 1171, and 1191 include CPUs 1112, 1132, 1152, 1172, and 1192 respectively, memories 1113, 1133, 1153, 1173, 1193 respectively, network layer circuitry 1114, 1134, 1154, 1174, and 1194 respectively, NIUs 1115, 1135, 1155, 1175, and 1195 respectively, and routers 1116, 1136, 1156, 1176, and 1196 respectively. Although five nodes are shown, any quantity of nodes may be possible. Additionally, although one CPU and per node is shown, a node may have multiple CPUs, etc. Memory may include one or more L1 caches, one or more L2 caches, one or more L3 caches, and other memory. Memories may be partitioned.

Computation system 1102 may divide complex computation 1101 into multiple component computations, such as component computations 1110, 1130, 1170, and 1190. The component computations may also be referred to as instructions, such that computation system 1102 may divide complex computation into a set of instructions and distribute the instructions to the nodes. Each node may perform different component computations of complex computation 1101.

Node 1111 may receive component computation 1110. Component computation 1110 may not use the entire memory 1113. Accordingly, memory 1113 may be partitioned such that memory portion 1118 is reserved for use by node 1111 while memory portion 1119 is available for use by other nodes in computation system 1102. As shown, node 1131 may use memory portion 1119 of node 1111 for executing component computation 1130.

Node 1131 may receive component computation 1130. Component computation 1130 may use the entire memory 1133. Accordingly, memory 1133 may correspond to a single memory portion 1138, which is reserved for use by node 1131. Additionally, node 1131 may use memory portion 1119 (e.g., a shared remote memory) from node 1111 to execute component computation 1130. Node 1131 may also use memory portion 1159 (e.g., another shared remote memory) to execute component computation 1130. That is, node 1131 may use memory 1133, memory portion 1119, and memory portion 1159 to execute component computation 1130.

Node 1151 may be idle or inactive. In specific embodiments, CPU 1152 may be powered off while memory 1153 and network layer circuitry 1154 (including NIU 1155 and router 1156) may be powered on. Memory 1153 may include memory portion 1159. Memory portion 1159 may be used by another node to complete their respective component computation. For example, node 1131 may use memory portion 1159 to execute component computation 1130.

Node 1171 may receive component computation 1170. Component computation 1170 may not use the entire memory 1173. Accordingly, memory 1173 may be partitioned such that memory portion 1178 is reserved for use by node 1171 while memory portions 1179 and 1180 are available for use by other nodes in computation system 1102. In specific embodiments, Node 1191 may reserve memory portion 1180 for use in executing component computation 1190. In specific embodiments, other nodes may refrain from reserving memory portion 1179, as sufficient memory may already be reserved for the other component computations in the set of component computations. In specific embodiments, memory portion 1179 may be allocated to node 1111, for example if component computation 1110 uses more memory than originally estimated (e.g., memory portion 1118 may no longer be sufficient). In specific examples, memory portion 1179 may be allocated to node 1131, node 1191, or a node not depicted in system 1100.

Node 1191 may receive component computation 1190. Component computation 1190 may use the entire memory 1193. Accordingly, memory 1193 may correspond to a single memory portion 1198, which is reserved for use by node 1191. Additionally, node 1191 may use memory portion 1180 (e.g., a shared remote memory) from node 1171 to execute component computation 1190. That is, node 1191 may use memory portion 1198 and memory portion 1180 to execute component computation 1190.

When a first node (e.g., node 1111) within a network (e.g., including computation system 1102) reserves a portion of its memory (e.g., memory portion 1119) for exclusive use by a second node (e.g., node 1131), the network as a whole may operate more efficiently by allowing memory constrained component computations (e.g., component computation 1130) to be performed, and by utilizing memory that might otherwise be unutilized based on the component computation assigned to the first node. Furthermore, using approaches disclosed herein, otherwise unutilized nodes (e.g., node 1151) may be placed in an idle state in which the computation portion (e.g., CPU 1152) of the node is entirely powered off while the memory portion (e.g., memory 1153) of the node continues to operate and is used by another node (e.g., node 1131) in the network. Services may be more effectively allocated between nodes to maximize utilization.

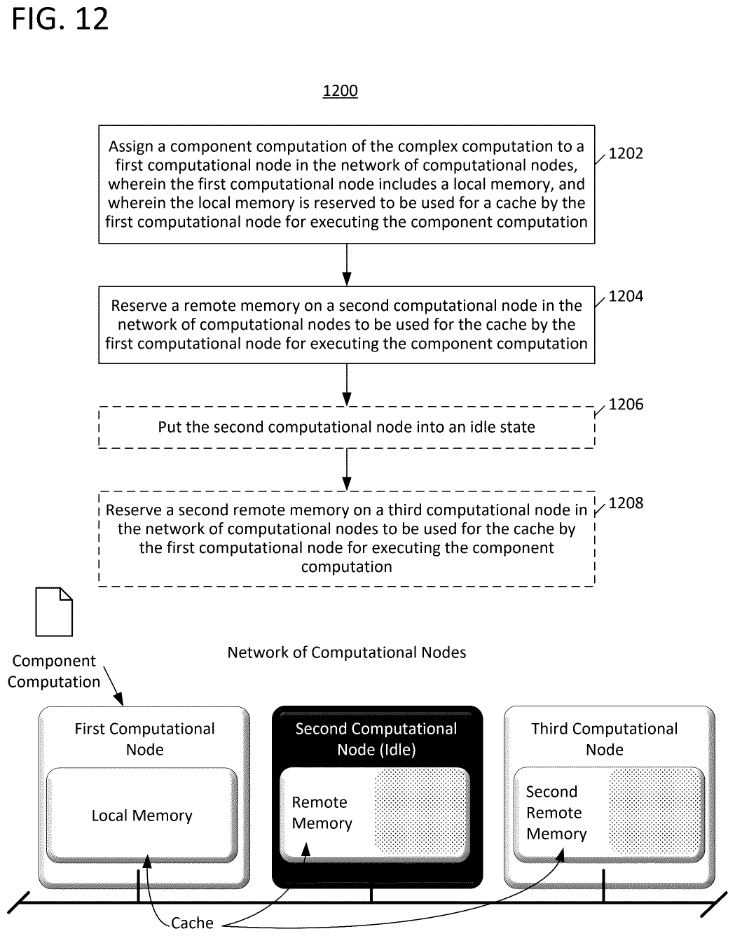

FIG. 12 illustrates method 1200 for executing a complex computation using a network of computational nodes in accordance with an embodiment of the present disclosure. The steps may be performed by a system including a combination of nodes, cores, processors, memories, networking, controllers, or other components such as those described in the present disclosure. Although particular steps are depicted in a particular order in FIG. 12, it will be understood that the order of certain steps may be modified in accordance with the present disclosure and that steps may be added or removed in certain embodiments. For example, in specific embodiments, steps (or portions of steps) may be performed in a different order, duplicated, omitted, or otherwise deviate from the organization shown.

At step 1202, a component computation of the complex computation may be assigned to a first computational node in the network of computational nodes. The first computational node may include a local memory. The local memory may be reserved to be used for a cache by the first computational node for executing the component computation. In specific embodiments, the local memory may be either a scratch pad memory or a first L1 layer cache of the first computational node. In specific embodiments, the local memory may be partitioned programmatically.

At step 1204, a remote memory on a second computational node in the network of computational nodes may be reserved to be used for the cache by the first computational node for executing the component computation. In specific embodiments, the remote memory may be partitioned programmatically. In specific embodiments, the first computational node and the second computational node may be executing different component computations of the complex computation. In specific embodiments, executing the component computation may include the second computational node using a shared remote memory (e.g., the remote memory shared with or allocated to the second computational node) as a cache for the second computational node in place of a portion of the remote memory being used by the first computational node. In specific embodiments, reserving (e.g., at step 1204) the remote memory on the second computational node in the network of computational nodes may be done at boot time.

In specific embodiments, the first computational node may have a first L1 layer cache and a first L2 layer cache. The second computational node may have a second L1 layer cache and a second L2 layer cache. Reserving (e.g., at step 1204) the remote memory on the second computational node in the network of computation nodes may include the second computational node partitioning (or repartitioning) at least a portion of the second L2 layer cache for use by the first computational node while saving the second L1 layer cache for exclusive use by the second computational node.

In specific embodiments, at step 1206, the second computational node may be put into an idle state (e.g., depicted in black). A CPU of the second computational node may be off in the idle state. The remote memory and the network layer circuitry of the second computational node may be on in the idle state. The network layer circuitry may comprise a NIU and a router.

In specific embodiments, at step 1208, a second remote memory on a third computational node in the network of computational nodes may be reserved to be used for the cache by the first computational node for executing the component computation. For example, the first remote memory, the second remote memory, and the local memory may be reserved to be used for cache by the first computational node for executing the component computation.

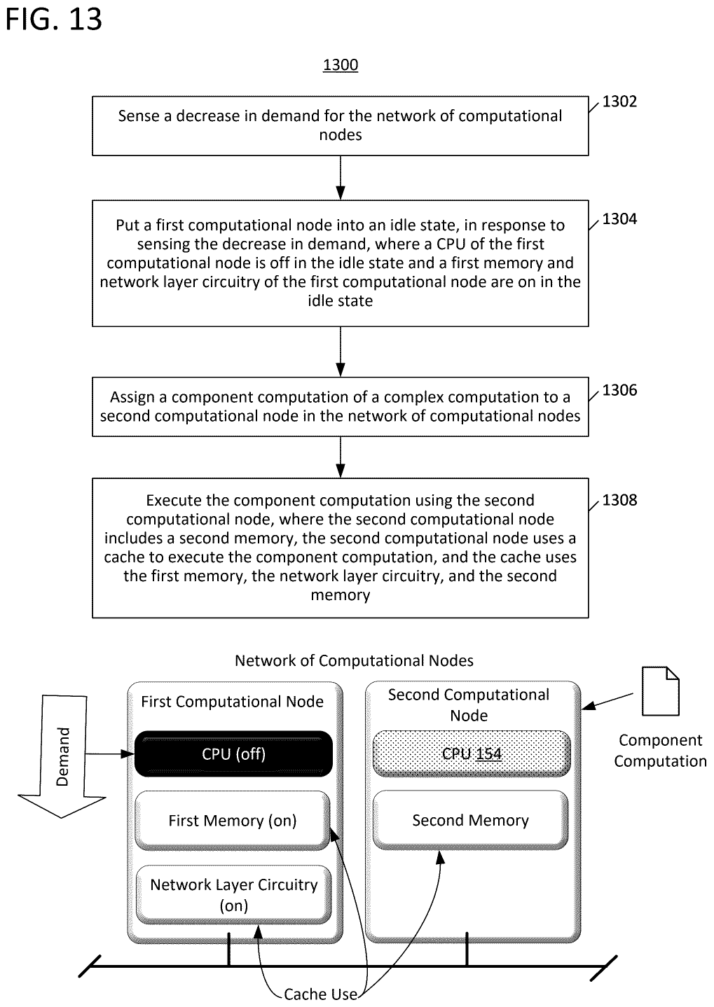

FIG. 13 illustrates method 1300 for operating a network of computational nodes in accordance with an embodiment of the present disclosure. The steps may be performed by a system including a combination of nodes, cores, processors, memories, networking, controllers, or other components such as those described in the present disclosure. Although particular steps are depicted in a particular order in FIG. 13, it will be understood that the order of certain steps may be modified in accordance with the present disclosure and that steps may be added or removed in certain embodiments. For example, in specific embodiments, steps (or portions of steps) may be performed in a different order, duplicated, omitted, or otherwise deviate from the organization shown.

At step 1302, a decrease in demand for the network of computational nodes may be sensed.

At step 1304, a first computational node may be put into an idle state. The first computational node may be put into the idle state in response to sensing the decrease in demand. A CPU of the first computational node may be off in the idle state. A first memory and network layer circuitry of the first computational node may be on in the idle state. In specific embodiments, the first memory comprises an L2 layer cache of the first computational node.

At step 1306, a component computation of a complex computation may be assigned to a second computational node in the network of computational nodes.

At step 1308, the component computation may be executed using the second computational node. The second computational node may include a second memory. The second computational node may use a cache to execute the component computation. The cache may use the first memory, the network layer circuitry, and the second memory.

When a first node (e.g., the first computational node) within a network reserves a portion of its memory (e.g., the first memory) for exclusive use by a second node (e.g., the second computational node), the network as a whole may operate more efficiently by allowing memory constrained component computations to be performed, and by utilizing memory (e.g., the first memory) that might otherwise be unutilized based on the idle state of the first node. Services may be more effectively allocated between nodes to maximize utilization.

At least one processor in accordance with this disclosure can include at least one non-transitory computer readable media. The at least one processor could comprise at least one computational node in a network of computational nodes. The media could include cache memories on the processor. The media can also include shared memories that are not associated with a unique computational node. The media could be a shared memory, could be a shared random-access memory, and could be, for example, a DDR DRAM. The shared memory can be accessed by multiple channels. The non-transitory computer readable media can store data required for the execution of any of the methods disclosed herein, the instruction data disclosed herein, and/or the operand data disclosed herein. The computer readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Approaches in the disclosure may be utilized by any interconnect fabric and any type of computational node. These and other modifications and variations to the present invention may be practiced by those skilled in the art, without departing from the scope of the present invention, which is more particularly set forth in the appended claims.

What is claimed is:

1. A method for executing a complex computation using a network of computational nodes comprising:
assigning a component computation of the complex computation to a first computational node in the network of computational nodes, wherein the first computational node includes a local memory, and wherein the local memory is reserved to be used for a cache by the first computational node for executing the component computation; and
reserving a remote memory on a second computational node in the network of computational nodes to be used for the cache by the first computational node for executing the component computation.

2. The method of claim 1, wherein:
the first computational node and the second computational node are executing different component computations of the complex computation.

3. The method of claim 1, further comprising:
putting the second computational node into an idle state;
wherein a CPU of the second computational node is off in the idle state and the remote memory and network layer circuitry of the second computational node are on in the idle state.

4. The method of claim 3, wherein:
the network layer circuitry comprises a network interface unit (NIU), and a router.

5. The method of claim 1, wherein executing the component computation includes:
the second computational node using a shared remote memory as a cache for the second computational node in place of a portion of the remote memory being used by the first computational node.

6. The method of claim 1, wherein:
the first computational node has a first L1 layer cache and a first L2 layer cache;
the second computational node has a second L1 layer cache and a second L2 layer cache; and
reserving the remote memory on the second computational node in the network of computational nodes includes the second computational node partitioning at least a portion of the second L2 layer cache for use by the first computational node while saving the second L1 layer cache for exclusive use by the second computational node.

7. The method of claim 1, wherein:
reserving the remote memory on the second computational node in the network of computational nodes is done at boot time.

8. The method of claim 1, wherein:
the local memory is either a scratch pad memory or a first L1 layer cache of the first computational node; and
the local memory is partitioned programmatically.

9. The method of claim 1, further comprising:
reserving a second remote memory on a third computational node in the network of computational nodes to be used for the cache by the first computational node for executing the component computation.

10. A network of computational nodes comprising:
a set of instructions for a complex computation distributed amongst the computational nodes in the network of computational nodes;
a first computational node;
a memory on the first computational node reserved to be used as a cache by the first computational node for executing a component computation from the complex computation;
a second computational node; and
a memory on the second computational node reserved to be used for the cache by the first computational node for executing the component computation.

11. The network of claim 10, wherein:
the first computational node executes a first component of the complex computation; and
the second computational node executes a second component of the complex computation, the second component being different than the first component.

12. The network of claim 10, wherein:
the second computational node is in an idle state;
a CPU of the second computational node is off while the second computational node is in the idle state; and
the memory on the second computational node and network layer circuitry of the second computational node are on while the second computational node is in the idle state.

13. The network of claim 12, further comprising:
a network interface unit (NIU) associated with the network layer circuitry; and
a router associated with the network layer circuitry.

14. The network of claim 10, wherein:
the second computational node uses a shared remote memory as a cache for the second computational node in place of a portion of the memory on the second computational node being used by the first computational node.

15. The network of claim 10, further comprising:
a first L1 layer cache associated with the first computational node;
a first L2 layer cache associated with the first computational node;
a second L1 layer cache associated with the second computational node; and
a second L2 layer cache associated with the second computational node;
wherein the memory on the second computational node in the network of computational nodes is reserved based at least in part on the second computational node repartitioning at least a portion of the second L2 layer cache for use by the first computational node while saving the second L1 layer cache for exclusive use by the second computational node.

16. The network of claim 10, wherein:
the memory on the second computational node in the network of computational nodes is reserved at boot time.

17. The network of claim 10, wherein:
the memory on the first computational node is either a scratch pad memory or a first L1 layer cache of the first computational node; and
the memory on the first computational node is partitioned programmatically.

18. The network of claim 10, further comprising:
a third computational node; and
a second remote memory on the third computational node to be used for the cache by the first computational node for executing the component computation.

19. A method for operating a network of computational nodes comprising:
sensing a decrease in demand for the network of computational nodes;
putting a first computational node into an idle state, in response to sensing the decrease in demand, where a CPU of the first computational node is off in the idle state and a first memory and network layer circuitry of the first computational node are on in the idle state;
assigning a component computation of a complex computation to a second computational node in the network of computational nodes; and
executing the component computation using the second computational node, where the second computational node includes a second memory, the second computational node uses a cache to execute the component computation, and the cache uses the first memory, the network layer circuitry, and the second memory.

20. The method of claim 19, wherein:
the first memory comprises an L2 layer cache of the first computational node.
